(19) United States
(12) Patent Application Publication
(10) Pub. No.: US 2024/0125905 A1
(43) Pub. Date: Apr. 18, 2024

(54) HYPERSPECTRAL MACHINE-READABLE SYMBOLS AND MACHINE-READABLE SYMBOL READER WITH HYPERSPECTRAL SENSOR

(71) Applicant: Datalogic IP Tech, S.r.l., Bologna (IT)

(72) Inventors: Simone Cilli, Bologna (IT); Matteo Lelli, Bologna (IT); Nicola Cuccato, Bologna (IT)

(21) Appl. No.: 17/966,688

(22) Filed: Oct. 14, 2022

(51) Int. Cl. G01S 7/481; G01S 17/89; G06K 7/10

(52) U.S. Cl. CPC G01S 7/4817; G01S 17/89; G06K 7/1097

(57) ABSTRACT

A machine-readable symbol reader can capture a cubic data set of an object carrying a machine-readable symbol. The machine-readable symbol reader can include a hyperspectral sensor, and the cubic data set may include image data for the machine-readable symbol within multiple, different wavelengths of the electromagnetic spectrum. The cubic data may be separated into portions that are each analyzed by specific processors, and those separate analyses can be used to increase the capabilities and efficiency compared to known machine-readable symbol readers.

### BACKGROUND

### Technical Field

The present disclosure relates to machine-readable symbol readers in general, and to machine-readable symbol readers that incorporate hyperspectral imaging cameras and capabilities.

### Description of the Related Art

Machine-readable symbols encode information in a form that can be optically read via a machine-readable symbol reader. Machine-readable symbols take a variety of forms, the most commonly recognized form being the linear or one-dimensional barcode symbol. Other forms include two-dimensional machine-readable symbols such as stacked code symbols, and area or matrix code symbols. These machine-readable symbols are typically composed of patterns of high and low reflectance areas.

For instance, a barcode symbol may comprise a pattern of black bars on a white background. Also for instance, a two-dimensional symbol may comprise a pattern of black marks (e.g., bars, squares or hexagons) on a white background. Machine-readable symbols are not limited to being black and white, but may comprise two other colors, may include more than two colors (e.g., more than black and white). Machine-readable symbols may include directly marked materials (i.e., direct part marking or DPM) having the symbols formed in surface relief (e.g., etched or otherwise inscribed in a surface).

Machine-readable symbols are typically composed of elements (e.g., symbol characters) which are selected from a particular machine-readable symbology. Information is encoded in the particular sequence of shapes (e.g., bars) and spaces which may have varying dimensions. The machine-readable symbology provides a mapping between machine-readable symbols or symbol characters and human-readable symbols (e.g., alpha, numeric, punctuation, commands). A large number of symbologies have been developed and are in use, for example Universal Product Code (UPC), European Article Number (EAN), Code 39, Code 128, Data Matrix, PDF417, etc.

Machine-readable symbols have widespread and varied applications. For example, machine-readable symbols can be used to identify a class of objects (e.g., merchandise) or unique items (e.g., patents). As a result, machine-readable symbols are found on a wide variety of objects, such as retail goods, company assets, and documents, and help track production at manufacturing facilities and inventory at stores (e.g., by scanning items as they arrive and as they are sold). In addition, machine-readable symbols may appear on a display of a portable electronic device, such as a mobile telephone, personal digital assistant, tablet computer, laptop computer, or other device having an electronic display.

Machine-readable symbol readers or data readers are used to capture images or representations of machine-readable symbols appearing on various surfaces to read the information encoded in the machine-readable symbol. One commonly used machine-readable symbol reader is an imager- or imaging-based machine-readable symbol reader. Imaging-based machine-readable symbol readers typically employ flood illumination to simultaneously illuminate the entire machine-readable symbol, either from dedicated light sources, or in some instances using ambient light. This is in contrast to scanning or laser-based (i.e., flying spot) type machine-readable symbol readers, which scan a relatively narrow beam or spot of light sequentially across the machine-readable symbol. Machine-readable symbol readers are commonly referred to as a “scanner” or “barcode scanner” whether they employ flood illumination or a scanning laser beam, or whether they read one-dimensional or two-dimensional machine-readable symbols.

Imaging-based machine-readable symbol readers typically include solid-state image circuitry, such as charge-coupled devices (CCDs) or complementary metal-oxide semiconductor (CMOS) devices, and may be implemented using a one-dimensional or two-dimensional imaging array of photosensors (or pixels) to capture an image of the machine-readable symbol. One-dimensional CCD or CMOS readers capture a linear cross-section of the machine-readable symbol, producing an analog waveform whose amplitude represents the relative darkness and lightness of the machine-readable symbol.

Two-dimensional CCD or CMOS readers may capture an entire two-dimensional image. The image is then processed to find and decode a machine-readable symbol. For example, virtual scan line techniques for digitally processing an image containing a machine-readable symbol sample across an image along a plurality of lines, typically spaced apart and at various angles, somewhat like a scan pattern of a laser beam in a scanning or laser-based scanner.

Reading a symbol typically employs generating an electrical signal or digital value having an amplitude determined by the intensity of the collected light. Relatively less reflective or darker regions (e.g., bars or other marks) may, for example, be characterized or represented in the electrical signal or digital value by an amplitude below a threshold amplitude, while relatively more reflective or lighter regions (e.g., white spaces) may be characterized or represented in the electrical signal or digital value by an amplitude above the threshold amplitude.

When the machine-readable symbol is scanned using laser or “flying spot,” positive-going and negative-going transitions in the electrical signal occur, signifying transitions between darker regions and lighter regions. Techniques may be used for detecting edges of darker regions and lighter regions by detecting the transitions of the electrical signal. Techniques may also be used to determine the dimensions (e.g., width) of darker regions and lighter regions based on the relative location of the detected edges and decoding the information represented by the machine-readable symbol.

Challenges for conventional machine-readable symbol readers include differentiating similar machine-readable symbols (e.g., that appear to be the same color in the visible spectrum), and differentiating a machine-readable symbol from a detailed background. The limited number of inputs available to conventional machine-readable symbol readers restrict the ability of machine-readable symbol readers to overcome these and other challenges.

### BRIEF SUMMARY

Hyperspectral imaging represents a powerful extension of the traditional concept of digital imaging, which exploits spectroscopy to obtain additional information on a captured image/scene. The inclusion of the spectroscopic contribution evolves a captured data set from a classic 2D (x, y) image output to a 3D (x, y, λ) cubic data output. The number of spectral channels or bands (and the width of the channels/bands) on which an analysis is performed is what differentiates multispectral and hyperspectral imaging.

Multispectral remote sensing typically involves the acquisition of visible, near-infrared, and short-wave infrared images. These images are acquired in several (e.g., three) broad wavelength bands. A multispectral image captures the image data within a specific wavelength range across the electromagnetic spectrum. Colors within the captured image are identifiable based on an analysis of the image data across the range of wavelengths, with each color producing a signal that includes various peaks at various specific frequencies within the range of wavelengths.

Hyperspectral remote sensing analyzes a wide spectrum of light to obtain a spectrum from each pixel in the captured image (e.g., to identify materials). There are different techniques/modalities to get the hyperspectral cube of data for a captured image/scene. The acquisition modalities can be divided in two main categories: snapshot mode and scanning mode.

Snapshot mode captures the entire data cube with a single snapshot, ensuring a very short acquisition time and the absence of artifacts. Due to high realization costs, snapshot mode is not typically used in commercial applications. Scanning mode is the more common technique, and can be applied in two modalities: spatial scanning and spectral scanning.

Spatial scanning analyzes one narrow spatial line of the scene/image at a time. The light that passes through the spatial line is split into its spectral components by a dispersive element, typically a prism or a diffraction grating. The dispersed light is then focused on a 2D sensor, wherein one dimension of the sensor images one of the spatial directions, and the other dimension captures the intensity of each wavelength present in the incoming light. Each captured spatial line thus results in a (y, λ) output. Additional spatial lines are scanned to obtain information regarding the other spatial direction (i.e., the (x) output) and fill the hyperspectral data cube.

Spectral scanning uses an optical band-pass filter to select a certain portion of the electromagnetic spectrum. Each snapshot is acquired using an optical filter peaked at a determined wavelength. Only the wavelengths that lie in a narrow region of the electromagnetic spectrum can pass through the filter and reach the detector, which captures the two-spatial direction of the scene (i.e., the (x, y) output). The scene is then spectrally scanned changing the peak wavelength of the band-pass filter to capture the (λ) data, and fill the hyperspectral cube. The optical filtering of the light can be performed using a series of optical filters or a single tunable filter, such as a Liquid Cristal Tunable Filter (LCTF) or an Acousto-Optical Tunable Filter (AOTF).

The fine wavelength resolution of hyperspectral imaging enables the detection of small variations in the reflection response of various objects to electromagnetic radiation. This kind of analysis has applications, for example in improved decoding performance and product quality verification. While a traditional RGB sensor distinguishes between inks with different colors, a hyperspectral sensor may distinguish between inks of the “same” color (as viewed in the visible spectrum). The visible spectrum may include the portion of the electromagnetic spectrum between about 380 nm and about 750 nm.

According to one aspect of the disclosure, systems and methods of the present disclosure analyze both a “visible” image (based on spectral data) and hyperspectral data for a captured image. The “visible” image may be obtained by using a hyperspectral sensor and extracting color components or pixel values (e.g., based on the known signal response of red, green, and blue in specific wavelengths). Alternatively, or in addition, the “visible” image may be obtained by using a standard camera sensor (e.g., an RGB sensor). The combination of these two data sets enables the use of an improved decoding library.

According to one aspect of the disclosure an imager may be used to establish originality of a document. An analysis of the ink present on a document may be analyzed, and even if the ink appears to be consistent (e.g., all of the ink appears to be the same color as viewed in the visible spectrum), a hyperspectral analysis of the ink may reveal that two or more different inks are present within the document. This may be an indicator that the first ink represents the original document, and the second ink was used to alter the document.

According to one aspect of the disclosure a machine-readable symbol reader includes a hyperspectral sensor and an image processor. The hyperspectral sensor captures image data of an object within a field of view of the hyperspectral sensor. The captured image data includes a 3D cubic data set, and the 3D cubic data set includes a plurality of 2D planar data sets. Each of the plurality of 2D planar data sets is captured within a discrete range of wavelengths of the electromagnetic spectrum.

The image processor is communicatively coupled to the hyperspectral sensor such that a first subset of the captured image data is received by the image processor and a second subset of the captured image data is excluded from the image processor. The first subset of the captured image data includes at least one of the plurality of the 2D planar data sets captured at a selected one of the discrete ranges of wavelengths of the electromagnetic spectrum. Each of the selected ones of the discrete range of wavelengths is a range of wavelengths in which at least a portion of a machine-readable symbol carried by the object is present and a background of the object is absent.

According to one aspect of the disclosure, a method of decoding a machine-readable symbol includes capturing image data of an object and a machine-readable symbol carried by the object with a hyperspectral sensor of a machine-readable symbol reader when the object and the machine-readable symbol are positioned within a field of view of the hyperspectral sensor. The machine-readable symbol is formed by a first material and the object includes a second material that forms no part of the machine-readable symbol. The method further includes identifying at least one range of wavelengths of the electromagnetic spectrum in which the first material is present within the captured image data and the second material is absent from the captured image data, sending a portion of the captured image data to an image processor communicatively coupled to the hyperspectral sensor, wherein the portion of the captured image data includes at least one 2D planar data set captured at the identified at least one range of wavelengths, and decoding the machine-readable symbol.

According to one aspect of the disclosure a machine-readable symbol reader includes a hyperspectral sensor, an image processor, and a hyperspectral processor. The hyperspectral sensor captures image data for an object within a field of view of the hyperspectral image sensor, and the captured image data includes a 3D cubic data set. The image processor is communicatively coupled to the hyperspectral sensor such that a first subset of the captured image data is received by the image processor, and the first subset of the captured image data is a 2D planar data set that includes a machine-readable symbol carried by the object.

The hyperspectral processor is communicatively coupled to the hyperspectral sensor such that a second subset of the captured image data is received by the hyperspectral processor, and the second subset of the captured image data includes a plurality of linear data sets. The hyperspectral processor identifies locations within the captured image data in which the object is absent, and communicates the identified locations to the image processor. The image processor identifies a region of interest within the first subset of the captured image data, and the region of interest excludes the identified locations.

According to one aspect of the disclosure, a method of decoding a machine-readable symbol includes capturing image data of an object and a machine-readable symbol carried by the object with a hyperspectral sensor of a machine-readable symbol reader when the object and the machine-readable symbol are positioned within a field of view of the hyperspectral sensor. The object includes a first material. The method further includes sending a first subset of the captured image data to an image processor communicatively coupled to the hyperspectral sensor, and the portion of the captured image data includes at least one 2D planar data set.

The method further includes sending a second subset of the captured image data to a hyperspectral processor communicatively coupled to the hyperspectral sensor, analyzing the second subset of the captured image data to identify locations within the captured image data in which the first material is absent, communicating the identified locations to the image processor, and identifying a region of interest within the first subset of the captured image data. The region of interest is reduced in size compared to the first subset of the captured image data, and the region of interest excludes the identified locations. The method further includes analyzing the region of interest to decode the machine-readable symbol.

According to one aspect of the disclosure, a method of decoding a machine-readable symbol includes capturing image data of an object and a machine-readable symbol carried by the object with a hyperspectral sensor of a machine-readable symbol reader when the object and the machine-readable symbol are positioned within a field of view of the hyperspectral sensor, wherein the object includes a first material. The method further includes sending a first subset of the captured image data to an image processor communicatively coupled to the hyperspectral sensor, wherein the portion of the captured image data includes at least one 2D planar data set.

The method further includes sending a second subset of the captured image data to a hyperspectral processor communicatively coupled to the hyperspectral sensor, analyzing the second subset of the captured image data to identify locations within the captured image data in which the first material is absent, communicating the identified locations to the image processor, and identifying a region of interest within the first subset of the captured image data. The region of interest is reduced in size compared to the first subset of the captured image data, and the region of interest excludes the identified locations. The method further includes analyzing the region of interest to decode the machine-readable symbol.

According to one aspect of the disclosure, a method of reducing a captured image data set includes capturing a 3D cubic data set of image data of an object with a hyperspectral sensor when the object is positioned within a field of view of the hyperspectral sensor, wherein the 3D cubic data set includes a plurality of 2D planar data sets each captured within respective discrete ranges of wavelengths of the electromagnetic spectrum.

The method further includes identifying a subset of the 3D cubic data set that includes all of the plurality of 2D planar data sets captured within discrete range of wavelengths of the electromagnetic spectrum that are between a minimum wavelength and a maximum wavelength, and determining a signal intensity for each pixel of the 2D planar data set within each of the discrete range of wavelengths of the electromagnetic spectrum that are between the minimum wavelength and the maximum wavelength. The method further includes calculating a cumulative signal intensity for each pixel of the 2D planar data set by summing the signal intensity of each pixel across each of the discrete range of wavelengths of the electromagnetic spectrum that are between the minimum wavelength and the maximum wavelength, comparing the cumulative signal intensity for each pixel of the 2D planar data set to a threshold value, and identifying a region of interest within the 2D planar data set that includes only those pixels in which the cumulative signal intensity is greater than or equal to the threshold value.

According to one aspect of the disclosure, a method of reducing a captured image data set includes capturing a 3D cubic data set of image data of an object with a hyperspectral sensor when the object is positioned within a field of view of the hyperspectral sensor, wherein the 3D cubic data set includes a plurality of 2D planar data sets each captured within respective discrete ranges of wavelengths of the electromagnetic spectrum. The method further includes identifying a subset of the 3D cubic data set that includes one of the 2D planar data sets captured within a discrete range of wavelengths of the electromagnetic spectrum, determining a signal intensity for each pixel of the 2D planar data set of the subset, comparing the signal intensity for each pixel of the 2D planar data set of the subset to a threshold value, and identifying a region of interest within the 2D planar data set of the subset that includes only those pixels in which the signal intensity is greater than or equal to the threshold value.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 is a block diagram of a machine-readable symbol reader and an object bearing a machine-readable symbol to be read, according to at least one illustrated embodiment.

FIG. 2 is an image of a surface of an object that includes a detailed background, and a machine-readable symbol carried by the object.

FIG. 3 is an image of the surface of the object illustrated in FIG. 2, with the detailed background removed/excluded.

FIG. 4 is a block diagram of a machine-readable symbol reader and an object bearing a machine-readable symbol to be read, according to at least one illustrated embodiment.

FIG. 5 is a schematic diagram of the machine-readable symbol reader illustrated in FIG. 4, and a conveyor transporting multiple objects, each carrying a machine-readable symbol, through a field of view of the machine-readable symbol reader.

FIG. 6 is an image of the conveyor and one of the objects illustrated in FIG. 5, the image captured by the machine-readable symbol reader illustrated in FIG. 4 while the conveyor and the object are within the machine-readable symbol reader's field of view.

FIG. 7 is the image illustrated in FIG. 6, identifying a reduced region of interest within the field of view of the machine-readable symbol reader illustrated in FIG. 4.

FIG. 8 is a schematic diagram of a method of reducing a region of interest within a data set, according to one illustrated embodiment.

FIG. 9 is a schematic diagram of a method of reducing a region of interest within a data set, according to one illustrated embodiment.

FIG. 10 is a block diagram of a machine-readable symbol reader and an object bearing a machine-readable symbol to be read, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the machine-readable symbol readers have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

As used in this specification and the appended claims, the terms “active light source” or “active illumination source” mean a device or structure that generates light. Examples of active light sources or active illumination sources include, but are not limited to light emitting diodes (LEDs), flash strobes, incandescent or fluorescent lamps, or halogen bulbs. Such are typically responsive to some stimulus, for example an electric current or voltage.

As used in this specification and the appended claims, the terms “passive light source” or “passive illumination source” mean a device or structure that emits light but does not itself generate light. Examples of passive light sources or passive illumination sources include, but are not limited to optical waveguides (e.g., cylindrical waveguide, rectangular waveguide), light pipe, light transmissive substrates, reflectors, refractors, prisms, lenses, nanocrystalline structures. Such are typically illuminated by an active illumination or light source.

The headings and Abstract of the Disclosure provided herein are for convenience only and do not limit the scope or meaning of the embodiments.

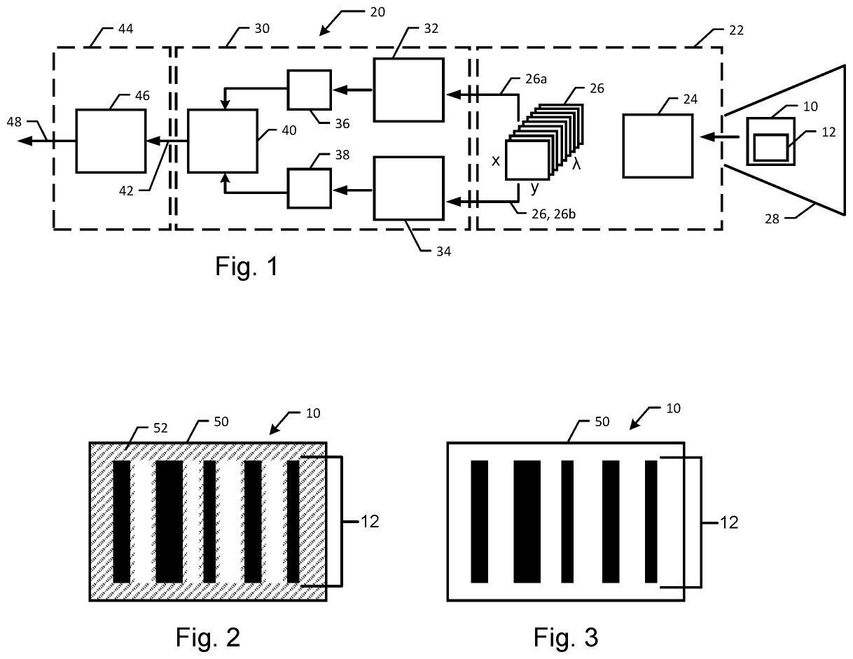

Referring to FIG. 1, a machine-readable symbol reader 20 may include an acquisition unit 22 that acquires a data set for a target object 10 that includes a machine-readable symbol 12. In some embodiments, the machine-readable symbol reader 20 may be implemented as a fixed retail scanner, including single plane scanners, multi-plane (e.g., bi-optics) scanners, presentation scanners, etc., such as having a form factor similar to the Magellan product line of scanners available from Datalogic. In some embodiments, the machine-readable symbol reader 20 may be implemented as a handheld scanner, such as having a form factor similar to the PowerScan, QuickScan, Gryphon, and other similar products lines available from Datalogic. Other form factors for scanners are also contemplated, including wearable scanners, mobile computers with scanning capabilities, industrial scanners for transportation and logistics applications, among others that would be recognized by those skilled in the art.

As shown, the acquisition unit 22 may include a hyperspectral sensor 24 that acquires a 3D (x, y, λ) cubic data set 26 for the target object 10 when the target object 10 is within a field of view 28 of the machine-readable symbol reader 20 (e.g., within a field of view of the hyperspectral sensor 24).

The machine-readable symbol reader 20 may include a processing unit 30. As shown, the acquisition unit 22 may output the cubic data as two subsets: a first subset 26a (e.g., the x, y “image” data) may be output to an image processor 32; and a second subset 26b (e.g., the λ “feature” data) may be output to a hyperspectral processor 34. According to one embodiment, the first subset 26a may be a 2D or “planar” data set. According to one embodiment, the second subset 26b may be a plurality of 1D or “linear” data sets. The image processor 32 may include a decoding library that contains a database of information about machine-readable symbols (e.g., 1D or 2D codes). According to one embodiment, the image processor 32 may receive the first subset 26a of the data set 26 and output code information 36 (e.g., that identifies an object associated with a machine-readable code captured by the acquisition unit 22).

According to one embodiment, the second subset 26b may include at least a portion (up to an entirety of) the 3D (x, y, λ) cubic data set 26. Thus, the image processor 32 may receive and analyze a portion of the cubic data set 26, and the hyperspectral processor 34 may analyze a different portion (e.g., an entirety) of the cubic data set 26.

The hyperspectral processor 34 may receive the second subset 26b of the data set 26 and extract selected features 38 from the portion of the electromagnetic spectrum captured by the hyperspectral sensor 24. The hyperspectral processor 34 may then output the extracted features 38, as shown. The two outputs: the code information 36 from the image processor 32; and the extracted features 38 from the hyperspectral processor 34 may then be sent to a third processor 40. The third processor 40 may then use the combined outputs from the image processor 32 and the hyperspectral processor 34 to create a final output 42.

In other words, the final output 42 includes both code information 36 and the extracted features 38. In some embodiments, the code information 36 and the extracted features 38 may be transmitted on separate channels to an external device or host that performs the combination.

In some embodiments, one or more of the image processor 32, hyperspectral processor 34, and/or the third processor 40 may be separate processing devices of the machine-readable symbol reader 20 configured as describe herein. In some embodiments, one or more of the image processor 32, hyper spectral processor 34, and/or the third processor 40 may be implemented in separate cores of a multi-core processor or as multiple threads of a single processor.

According to one aspect of the disclosure, the extracted selected features 38 may include quality information, identification information, or both. For example, if the object 10 is an item of food, the machine-readable symbol 12 carried by the food may enable the machine-readable symbol reader 20 (e.g., the image processor 32 via the first subset 26a) to identify the specific type of food (e.g., apple, pear, etc.) via a decoding library decoding the machine-readable symbol 12 to obtain such information. Upon identification of the specific type of food, the machine-readable symbol reader 20 may retrieve information (e.g., via a database) about the specific type of food (e.g., an expected response within select ranges of the electromagnetic spectrum) and compare to the extracted features 38 determined by the hyperspectral processor 34 (via analysis of the second subset 26b).

Confirmation that the extracted features 38 are within the expected response may result in a determination by the machine-readable symbol reader 20 that the object 10 (the specific food item) is accurately matched with its machine-readable symbol and/or is of good quality (e.g., is fresh or unspoiled). Conversely, results within the extracted features 38 that are outside the expected response may result in a determination by the machine-readable symbol reader 20 that the object 10 (the specific food item) is of poor quality (e.g., is spoiled or is bruised). Such an analysis may be performed at checkout to ensure item validation (e.g., reduce sweethearting or label swapping) or ensuring item quality at purchase by a customer. In some embodiments, a supermarket employee may use such a handheld device to verify the accuracy of product labels while also analyzing product quality and remedying any mismatch or resolving other issues.

According to one aspect of the disclosure, the extracted selected features 38 may include information that identifies the material upon which the machine-readable symbol 12 is carried (e.g., a material on a label upon which the machine-readable symbol 12 is printed or a material of the object 10 upon which the machine-readable symbol 12 is carried directly or upon which a label carrying the machine-readable symbol 12 is secured). Using such information, the item may be validated in relation to the decoded machine-readable symbol. For example, upon identification of the specific type of item, the machine-readable symbol reader 20 may retrieve information (e.g., via a database) about the specific item (e.g., an expected response within select ranges of the electromagnetic spectrum for the packaging material known to be used for the item) and compare to the extracted features 38 determined by the hyperspectral processor 34 (via analysis of the second subset 26b). If the decoded barcode indicates a product having a cardboard packaging, but the spectral response does not match such packaging (e.g., is more similar to a spectral response for glass) then an alert may be generated indicating a mismatch (and possible label swapping or other problem to be resolved).

The machine-readable symbol reader 20 may include an output interface 44. The output interface 44 may include an output transmitter 46 that receives the final output 42 and transmits information 48 (e.g., to another device such as a POS system, remote host, a mobile device, an electronic display for display of such information to a user, etc.) based on the received final output 42. According to one embodiment, the transmitted information 48 may be a message on an output channel (e.g., Ethernet, fieldbuses, serial, etc.). According to one embodiment, the transmitted information 48 may be an actuation on an output signal (e.g., a signal for a mechanical actuator that moves a switch on a conveyor belt).

Referring to FIGS. 1 to 3, a machine-readable symbol decoding process may be difficult when a machine-readable symbol is printed on a detailed background. As shown in FIG. 2, the target object 10 may include a substrate 50 (e.g., a piece of paper, a cardboard box, etc.) with a detailed background 52. According to one embodiment, the detailed background 52 may include words, pictures, watermarks, etc. The machine-readable symbol 12 may be applied to the substrate 50 (e.g., over top of or adjacent to at least a portion of the detailed background 52.

The proximity of the detailed background 52 to the machine-readable symbol 12 may increase the amount of time needed for an image processor to decode the machine-readable symbol 12. This may be especially true if the detailed background 52 and the machine-readable symbol 12 appear to be the same/a similar color when viewed in the visible spectrum.

According to one embodiment, the first subset 26a of the data set 26 may include the x, y “image” data and portions of the λ data set. The portions of the λ data set may include wavelengths within which the machine-readable symbol 12 is present within the data set 26 and the detailed background is absent from the data set 26, as shown in FIG. 3. As used herein, being “present” within the data set 26 may include producing a signal intensity above a minimum threshold while being “absent” within the data set 26 may include producing a signal intensity below that minimum threshold. According to one embodiment, being “present” within the data set 26 may include producing a signal intensity that is at least five times greater than a signal intensity produced by something “absent” from the data set 26. According to one embodiment, being “present” within the data set 26 may include producing a signal intensity that is at least ten times greater than a signal intensity produced by something “absent” from the data set 26.

According to one embodiment, the first subset 26a of the data set 26 may include one or more selected spectral bands (e.g., portions of the λ data set) in which the machine-readable symbol 12 is visible and the detailed background is minimized/invisible/excluded, as shown in FIG. 3. The minimization/exclusion of extraneous information (i.e., anything other than the machine-readable symbol 12, such as the detailed background 52) results in a faster decoding process for the image processor 32.

The image processor 32 may isolate and/or filter out extraneous data (e.g., to eliminate the detailed background 52) based on the received first subset 26a. According to one embodiment, the machine-readable symbol reader 20 (e.g., the image processor 32) may include a new decoding library that contains a database of information addressed directly to machine-readable symbols (e.g., 1D or 2D codes) without consideration for potential extraneous information (e.g., the detailed background 52) in proximity to the machine-readable symbols. As a result of the image processor 32 eliminating the detailed background 52, the new decoding library may be implemented. Because the extraneous data is filtered out prior to receipt by the decoding library, there is no need for the decoding library to have to consider potential extraneous information. This may result in a faster, more efficient decoding of the machine-readable symbol 12.

According to another aspect, the hyperspectral processor 34 may filter the x, y image data to include only a portion of the x, y image data with a certain response (e.g., signal intensity) that identifies those portions of the x, y image data as corresponding to the machine-readable symbol 12. The filtered portion of the x, y image data may then be output to the image processor 32, thereby eliminating extraneous data and enabling the use of the decoding library that contains a database of information addressed directly to machine-readable symbols without consideration for potential extraneous information.

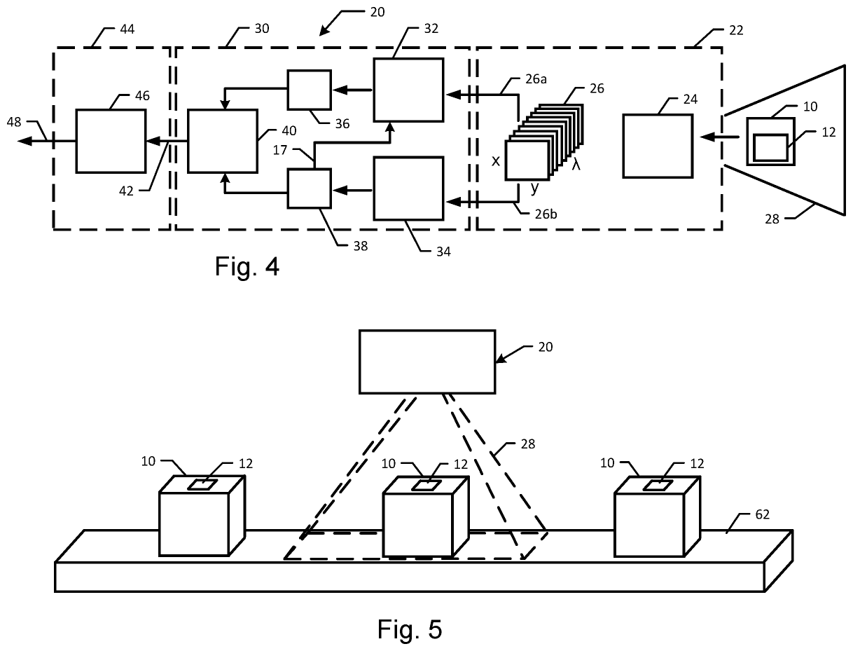

Referring to FIGS. 4 to 7, the machine-readable symbol reader 20 (e.g., the image processor 32, the hyperspectral processor 34) may identify a region of interest 60 within the data set 26. The region of interest (ROI) 60 may include at least a portion of the field of view 28 within which the machine-readable symbol 12 is located. According to one embodiment, the machine-readable symbol reader 20 may include features that reduce the region of interest 60. For example, the hyperspectral processor 34 may transmit extracted features 38 to the image processor 32, which may use such information to reduce the region of interest for the data processed by the decoding library. By reducing the region of interest, the decoding process may be sped up as there is less area to search/decode. According to one embodiment, the reduction of the region of interest may be enabled by the use of hyperspectral data (e.g., the data set 26 output by the hyperspectral sensor 24).

As shown in FIG. 5, a conveyor 62 may transport objects 10 (e.g., packages). The objects may carry respective machine-readable symbols 12. The machine-readable symbol reader 20 may be positioned relative to the conveyor 62 such that a portion of the conveyor 62 passes through the field of view 28 of the machine-readable symbol reader 20. As the objects 10 move via the conveyor 62, the objects 10, and their respective machine-readable symbols 12, pass through the field of view 28.

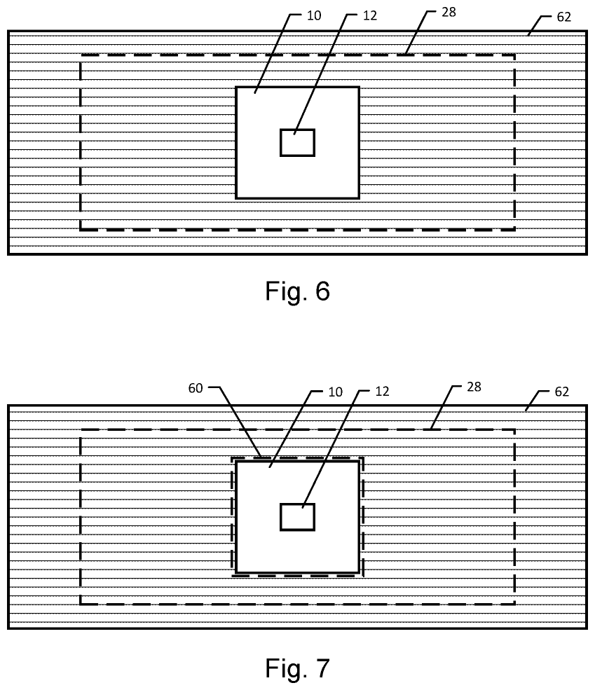

As shown in FIG. 6, the field of view 28 may be larger than the object 10, such that portions of the conveyor 62 are present within the field of view 28. Thus, captured images (e.g., from the acquisition unit 22) may include portions of the conveyor 62. If these portions of the conveyor 62 are included in the captured data 26 (e.g., the first subset 26a) that is sent to the image processor 32, time may be wasted/lost while the image processor 32 attempts to decode those portions of the data 26 that include the conveyor 62. Because it is known, in the illustrated embodiment, that the conveyor 62 does not carry a machine-readable symbol, it would be advantageous to eliminate/exclude the conveyor 62 from the first subset 26a that is sent to the image processor 32.

According to one embodiment, the material of the object 10 may be different than the material of the conveyor 62 (e.g., such that the material of the object 10 and the material of the conveyor 62 show up differently in select regions of the electromagnetic spectrum. For example, the object 10 may be made of cardboard, and the conveyor 62 may be made of rubber. If it is known that machine-readable symbols 12 are located on a material with a known response in terms of spectral image, the image processor 32 may be fed with information that enables the image processor 32 to work only on the portion of the full image with that known spectral image response.

Similar implementation of eliminating/excluding a platter area, a countertop area, etc. in a retail setting (e.g., checkout or self-checkout) employing a fixed retail scanner (e.g., bi-optic scanner) and/or other imagers in such a system is also contemplated as an embodiment of the disclosure. For example, the platter of a fixed retail scanner is typically a metallic surface (e.g., stainless steel), which may be distinguished from the material of an object (e.g., aluminum can, plastic bag, cardboard box, etc.) for reducing the region of interest of the data processed by the decoding library.

As shown in FIG. 7, the full image (represented by the field of view 28) may be reduced to a smaller region of interest 60 (e.g., that includes only the object 10, which carries the machine-readable symbol 12). With a smaller area to decode, the speed of the decoding performed by the image processor 32 may be improved.

As shown in FIG. 4, at least a portion 17 of the output (e.g., the features 38) from the hyperspectral processor 34 may be fed to the image processor 32. The portion 17 of the output may identify the reduced region of interest 60 within the first subset 26a, enabling the image processor 32 to exclude/ignore a remainder of the image outside the region of interest 60 during processing. Thus, a portion of the data set 26 (e.g., the second subset 26b, which may include the hyperspectral (A) data) collected by the hyperspectral sensor 24 may perform a role as metadata enriching another portion of the data set 26 (e.g., the first subset 26a, which may include the image (x, y) data) collected by the hyperspectral sensor 24.

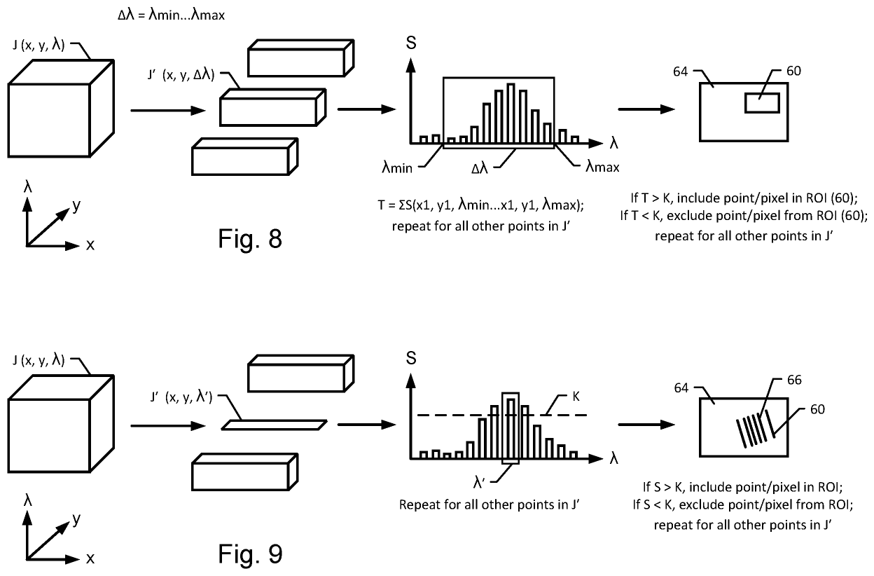

Referring to FIG. 8, a method of reducing a region of interest, which may be part of a method of decoding the machine-readable symbol 12, may include capturing hyperspectral image data J (e.g., the data set 26, which includes a 3D “cube” of data which may include the image data (x, y) and the feature data (λ)) of an object (e.g., the object 10) carrying a machine-readable symbol (e.g., the machine-readable symbol 12). The method may include partitioning/reducing the captured hyperspectral image data J. As shown, the captured hyperspectral image data J may be partitioned into a first portion J′ (e.g., a portion that includes (x) and (y) “image” data over a selected range Δλ of the (λ) data. The selected range Δλ may be bounded by a λₘᵢₙ value and a λₘₐₓ value and include every wavelength along the electromagnetic spectrum between the λₘᵢₙ value and the λₘₐₓ value for which data was captured. The hyperspectral image data J may be further partitioned into additional portions (e.g., a second portion that includes λ values below the λₘᵢₙ value and a third portion that includes A values above the λₘₐₓ value.

According to one aspect of the disclosure, the λₘᵢₙ value and the λₘₐₓ value are selected based on a material upon which the machine-readable symbol 12 is present. The selected values for the λₘᵢₙ value and the λₘₐₓ value may correspond to lower and upper values along the electromagnetic spectrum within which the material of the object 10 is “visible” (i.e., produces data captured by the hyperspectral sensor 24). For example, the machine-readable symbol 12 may be printed on a paper label, thus the selected values for the λₘᵢₙ value and the λₘₐₓ value are based on the electromagnetic response of paper. According to one example, the machine-readable symbol 12 may be present on a cardboard box (e.g., either printed directly or printed on a label, such as a paper label, that is secured to the cardboard box).

Thus, the method may include reducing the captured hyperspectral image data J to a reduced data set, the first portion J′. The remaining portion(s) of the captured hyperspectral image data J may be discarded/eliminated/excluded from further analysis.

As shown, the reduced data set (e.g., the first portion J′), may be further reduced. The bar graph portion of FIG. 8 illustrates a signal intensity value S for a single point/pixel (e.g., x1, y1) at various wavelengths of the electromagnetic spectrum λ. For each point/pixel that is within the reduced data set (e.g., the first portion J′), a cumulative signal intensity value T may be calculated by summing all of the signal intensities for each respective point/pixel within the range bounded by the λₘᵢₙ value and the λₘₐₓ value.

If the cumulative signal intensity value T for a respective point/pixel is greater than a selected threshold value K, the point/pixel is included in the region of interest 60, which may be output to an image processor (e.g., the image processor 32). If the cumulative signal intensity value T for a respective point/pixel is less than the selected threshold value K, the point/pixel is not included in the region of interest 60 (see area 64), which may be ignored by the image processor (e.g., the image processor 32). According to one aspect of the method, the cumulative signal intensity value T being equal to the threshold value K may be inclusive (such that the respective point is included in the region of interest 60) or exclusive (that the respective point is excluded from the region of interest 60).

The cumulative signal intensity value T may then be calculated for all of the other points (e.g., x2, y1; x3, y1; and so on) of the reduced data set (e.g., the first portion J′). Based on the outcome of the cumulative signal intensity value T comparison to the threshold value K, each of the other points may be included in the region of interest 60 (if T>K) or excluded from the region of interest 60 (if T<K).

According to one aspect of the disclosure, the cumulative signal intensity value T for a respective point/pixel may be analyzed over multiple wavelengths, a range of wavelengths, multiple ranges of wavelengths and compared to a selected threshold function K. If the intensity value T for the respective point/pixel is within a selected tolerance of the threshold function K, the point/pixel would be included in the region of interest 60, which may be output to an image processor (e.g., the image processor 32).

Thus, the method may include a further reduction of the captured hyperspectral image data J. After the reduction to the reduced data set, (e.g., the first portion J′), the reduced data set (e.g., the area 64) may be further reduced to a region of interest (e.g., the region of interest 60), such that only those points/pixels that have a cumulative signal intensity value T within the selected range Δλ are sent to the image processor (e.g., the image processor 32) for decoding. Alternatively, all of the points/pixels within the region of interest 60 may be sent to the image processor 32, and the specific points/pixels with the cumulative signal intensity value T within the selected range Δλ may be communicated to the image processor 32 (e.g., by the hyperspectral processor 34).

Although the method is described in terms of a single, contiguous selected range Δλ, aspects of the disclosure include the method operating across a plurality of discontinuous selected ranges. The method described above may enable the use of machine-readable symbols in various shapes and/or configurations in addition to squared/rectangular regions (e.g., scattered points, cloud, etc.). Thus, according to one embodiment, the region of interest 60 may include multiple, discrete regions, or may include scattered points in addition to or instead of one or more regions.

Referring to FIG. 9, one aspect of the disclosure includes a hyperspectral machine-readable symbol 66. The hyperspectral machine-readable symbol 66 may include an extravagant and unusual spectrum response (e.g., a spectrum response, for example a signal intensity value S, that is unique, known, easily identifiable, or any combination thereof compared to conventional machine-readable symbol ink, and also compared to conventional substrates for machine-readable symbols, such as paper, cardboard, etc.).

According to one aspect, the hyperspectral machine-readable symbol 66 may be produced by an ultraviolet marker, such that the hyperspectral machine-readable symbol 66 is fluorescent, transparent, and only visible under ultraviolet light. According to one aspect, the hyperspectral machine-readable symbol 66 is selected based on it having a known, recognizable spectrum response (e.g., one that is clearly different/distinguishable from the material upon which the hyperspectral machine-readable symbol 66 is to be placed.

The hyperspectral machine-readable symbol 66 as described herein may be used instead of or in addition to the machine-readable symbol 12 as described in any of the other embodiments of the disclosure.

Accordingly, a method of reducing a region of interest, which may be part of a method of decoding the hyperspectral machine-readable symbol 66, may include capturing hyperspectral image data J (e.g., the data set 26, which includes a 3D “cube” of data which may include the image data (x, y) and the feature data (λ)) of an object (e.g., the object 10) carrying a machine-readable symbol (e.g., the machine-readable symbol 12). The method may include partitioning/reducing the captured hyperspectral image data J. As shown, the captured hyperspectral image data J may be partitioned into a first portion J′ (e.g., a portion that includes (x) and (y) “image” data over a specific, scalar value of the (λ) data, referred to herein as λ′. The scalar value λ′ may be one in which hyperspectral machine-readable symbol 66 has the extravagant and unusual spectrum response. Thus, the first portion J′ may be a 2D “plane” of data that includes all of the (x, y) data within the scalar value λ′ of the (λ) data. The hyperspectral image data J may be further partitioned into additional portions (e.g., a second portion that includes λ values below the scalar value λ′ and a third portion that includes λ values above the scalar value λ′).

According to one aspect of the disclosure, the scalar value λ′ may be selected based on the material (e.g., ink) used to form (e.g., print) hyperspectral machine-readable symbol 66. Thus, the method may include reducing the captured hyperspectral image data J to a reduced (e.g., “2D”) data set, the first portion J′. The remaining portion(s) of the captured hyperspectral image data J may be discarded/eliminated/excluded from further analysis.

As shown, the reduced data set (e.g., the first portion J′), may be further reduced. The bar graph portion of FIG. 9 illustrates a signal intensity value S for a single point/pixel (e.g., x1, y1) at various wavelengths of the electromagnetic spectrum λ, including the scalar value λ′, which is indicated. For each point/pixel that is within the reduced data set (e.g., the first portion J′), the signal intensity value S may be measured/calculated at the scalar value λ′.

If the signal intensity value S for a respective point/pixel is greater than the selected threshold value K, which may be a different value than for the method described in reference to FIG. 8, the point/pixel is included in the region of interest 60, which may be output to an image processor (e.g., the image processor 32). If the signal intensity value S for a respective point/pixel is less than the selected threshold value K, the point/pixel is not included in the region of interest 60 (see area 64), which may be ignored by the image processor (e.g., the image processor 32). According to one aspect of the method, the signal intensity value S being equal to the threshold value K may be inclusive (such that the respective point is included in the region of interest 60) or exclusive (that the respective point is excluded from the region of interest 60).

The signal intensity value S may then be calculated for all of the other points (e.g., x2, y1; x3, y1; and so on) of the reduced data set (e.g., the first portion J′). Based on the outcome of the signal intensity value S comparison to the threshold value K, each of the other points may be included in the region of interest 60 (if S>K) or excluded from the region of interest 60 (if S<K).

Thus, the method may include a further reduction of the captured hyperspectral image data J. After the reduction to the reduced data set, (e.g., the first portion J′), the reduced data set (e.g., the area 64) may be further reduced to a region of interest (e.g., the region of interest 60), such that only those points/pixels that have a signal intensity value S within the scalar value λ′ are sent to the image processor (e.g., the image processor 32) for decoding.

Due to the selection of the specific scalar value λ′, in which the hyperspectral machine-readable symbol 66 has an extravagant and unusual spectrum response (e.g., a known, unique, predictable, signal intensity value S) the region of interest 60 result may include only the hyperspectral machine-readable symbol 66, and not a larger region that includes additional points in proximity to the hyperspectral machine-readable symbol 66 that are not part of the hyperspectral machine-readable symbol 66.

A reduced data set (e.g., the first portion J′) may be further reduced by building upon the method described above. A material (e.g., the hyperspectral machine-readable symbol 66, a substrate upon which the hyperspectral machine-readable symbol 66 is placed, or both) may have a known spectral response (e.g., a number of λ values each at respective, specific wavelengths). Analyzing the captured hyperspectral image data J results in a value for each point/pixel (x, y). The value may then be compared to known spectral response to determine if the point/pixel (x, y) should be included/discarded from the ROI, For example, when the known spectral response is for the hyperspectral machine-readable symbol 66, if the value for the point/pixel is within the threshold value K for each of the specific wavelengths of the known spectral response, the point/pixel may be included. When the known spectral response is for the substrate upon which the hyperspectral machine-readable symbol 66 is carried, if the value for the point/pixel is within the threshold value K for each of the specific wavelengths of the known spectral response, the point/pixel may be excluded.

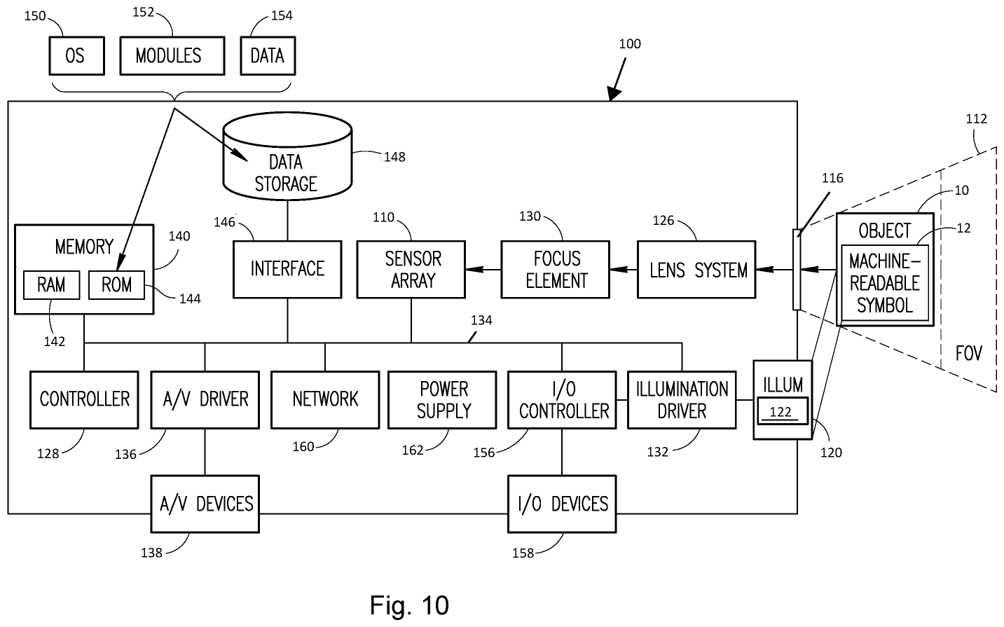

Referring to FIGS. 1 and 10, a machine-readable symbol reader 100 is illustrated as a block diagram, according to one implementation. Any or any combination of the components of machine-readable symbol reader 100 may be included in the machine-readable symbol reader 20 described herein. Similarly, any or any combination of the components of the machine-readable symbol reader 20 may be included in the machine-readable symbol reader 100 described herein. The machine-readable symbol reader 100 may include an image sensor or sensor array 110, which can capture images of a field of view 112 through a window 116. The field of view 112 can be focused onto the sensor array 110. Image frames captured by the sensor array 110 may include light emanating from one of the field of view 112. The image sensor array 110 may include one or more sensors that includes, for example, the hyperspectral sensor 24. Thus, the image sensor array 110 may be part of the acquisition unit 22.

The machine-readable symbol reader 100 may include one or more active light or illumination sources 120, which are operable to generate light and illuminate the field of view 112 in a forward direction (i.e., in front of a nose of the machine-readable symbol reader 100). The active illumination source(s) 120 can comprise any suitable source of light, such as one or more light emitting diodes (LEDs), flash strobes, incandescent or fluorescent lamps, or halogen bulbs. The active illumination source(s) 120 may generate light having one or more wavelengths or ranges of wavelength. The active illumination source(s) 120 can pass light or illumination through an optical element 122 prior to passing out of the machine-readable symbol reader 100 into an exterior or external environment. In some implementations the optical element 122 can take the form of a waveguide or other light transmissive structure.

As described with respect to specific implementations, the machine-readable symbol reader 100 can advantageously include an active or passive illumination source that emits light or illumination from a portion of the machine-readable symbol reader 100, for instance from a position spaced relatively below a head of the machine-readable symbol reader 100, and/or from a handle of the machine-readable symbol reader 100.

As shown in FIG. 10, the object 10 positioned within the field of view 112 may include a machine-readable symbol (e.g., the machine-readable symbol 12, the hyperspectral machine-readable symbol 66, or both). The machine-readable symbol 12 may be in a standard format (e.g., PDF417, Code 128, etc.) that is to be detected and/or decoded by the machine-readable symbol reader 100.

The machine-readable symbol reader 100 optionally includes a lens system 126 positioned and oriented to focus light onto the sensor array 110. For example, the lens system 126 may comprise an array of optics (e.g., optical elements) with a common optical axis. The lens system 126 may also comprise a zoom lens coupled to a controller 128 to control an amount of optical zoom.

The machine-readable symbol reader 100 optionally includes a focal element 130 disposed between the lens system 126 and the sensor array 110 such that at least some of the light rays arrive at the sensor array 110 through the focal element 130. The focal element 130 operates to provide one or more image focus distances for light rays that strike the sensor array 110. For example, in some implementations the focal element 130 is a thin plate of optical glass having a relatively high index of refraction n_{d} (e.g., n_{d} between 1.3 to 3.0) positioned over the sensor array 110.

The sensor array 110 forms an electronic image of the field of view 112. The sensor array 110 may comprise a wide range of image or optical sensing devices for converting an optical image (or another wavelength in the electromagnetic spectrum) into an electrical signal or digital representation. For example, the sensor array 110 may comprise a digital sensor, such as a charge-coupled device (CCD) sensor array or complementary metal-oxide semiconductor (CMOS) sensor array, both of which form a one-dimensional or two-dimensional array of pixels, which together constitute an electronic or digital representation of the image. Each pixel location stores data indicative of the light intensity at that location of the image. The light intensity data for each pixel (across one or more wavelengths of the electromagnetic spectrum) may represent a monochrome intensity (e.g., grayscale), or a color (e.g., red-green-blue). After the sensor array 110 has been exposed to light emanating from field of view 112, data from all the pixels can be sequentially read out in a selectable pattern (which may be row-by-row, sub-region by sub-region, or some other pattern). The pixel intensity data may optionally be converted to digital form using an analog-to-digital converter (not shown).

Typically, in response to receiving an instruction from a controller 128, the sensor array 110 captures or acquires one or more images of the field of view 112. Conceptually, a read volume of the machine-readable symbol reader 100 includes a portion of space in front of the window 116 in which machine-readable symbols may be read (e.g., detected and decoded) by the machine-readable symbol reader 100. In other words, the read volume may be referred to as a view volume within which there is a relatively high probability of a successful scan/read. The instruction may be generated in response to a user input, for example an activation (e.g., pull, pressing) of a switch, for example a trigger.

After the sensor array 110 has been exposed to light reflected or otherwise returned by the object 10, data from all or a portion of the pixels can be sequentially read out in a selectable pattern (which may be row-by-row, column-by-column, or some other pattern). The pixel intensity data may optionally be converted to digital form using an analog-to-digital converter (ADC) circuit before being supplied to the controller 128. The controller 128 may include or comprise a DSP, for example, a DSP architecture such as the Blackfin® processor family from Analog Devices, Norwood, Mass., or a microcontroller, such as the high-speed ARM® processor family from ARM Ltd., Cambridge, United Kingdom.

Briefly stated, the controller 128 processes the image data so as to attempt to decode a machine-readable symbol that has been focused onto the sensor array 110, and thus is denominated as a decode engine. The controller 128 may condition the data received from the sensor array 110 and may generate an output that generally identifies which regions of the image correspond to highly reflective or light areas, and which correspond to less reflective or dark areas, for example. The controller 128 may include one or more processors that includes, for example, the image processor 32, the hyperspectral processor 34, or both. Thus, the controller 128 may be part of the processing unit 30.

One or more illumination drivers or controllers 132 may apply signals to the active illumination source(s) 120 to, for example, strobe the active illumination source(s) 120 at desired times or in response to activation of a trigger by a user, or alternatively to light the active illumination source(s) 120 constantly for a period of time, for instance in response to actuation of a trigger by a user. The active illumination source(s) 120 can be mounted within a housing of the machine-readable symbol reader 100 (e.g., behind window 116), in a handle and/or in an extension.

The sensor array 110 and the illumination driver 132 may be communicatively coupled to the controller 128, which may be, for example, one or more of a processor, microprocessor, controller, microcontroller, digital signal processor (DSP), graphical processing unit (GPU), application specific integrated circuit (ASIC), programmable gate array (PGA), or the like (generally “processor”). Some implementations may include a dedicated machine-readable symbol scan module as the controller 128. The communicative coupling may be via a bus 134 or other communication mechanism, such as direct connections of a serial, parallel, or other type.

The controller 128 generally controls and coordinates the operation of other devices to which it is connected, such as one or more of the sensor array 110, the illumination driver 132, and an audio/visual (NV) driver 136. The A/V driver 136 is optionally included to drive one or more audio devices 138, such as a buzzer, speaker, or other audible indicator, to produce an audible “beep” or other indication when a machine-readable symbol is successfully read. In addition, or alternatively, the NV driver 136 may drive an LED or other visual indicator device 138 when a machine-readable symbol has been successfully read. Other devices or subsystems, such as a cash register or electronic scale, may also be connected to the controller 128. Moreover, the controller 128 and/or the bus 134 may interface with other controllers or computers, such as a cash register system or checkout terminal. Some implementations can include a user operable trigger or other switch, operation of which can cause the machine-readable symbol reader 100 to read machine-readable symbols.

The machine-readable symbol reader 100 may also include one or more non-transitory media, for example, memory 140, which may be implemented using one or more standard memory devices. The memory devices 140 may include, for instance, flash memory, RAM 142, ROM 144, and EEPROM devices, and the non-transitory media may also include magnetic or optical storage devices, such as hard disk drives, CD-ROM drives, and DVD-ROM drives. The machine-readable symbol reader 100 may also include an interface 146 coupled to an internal data storage 148, such as a hard disk drive, flash memory, an optical disk drive, or another memory or drive. The interface 146 may be configured for external drive implementations, such as over a USB or IEEE 1194 connection.

According to one implementation, any number of program modules are stored in the drives (e.g., data storage 148) and the memory 140, including an operating system (OS) 150, one or more application programs or modules 152, such as instructions to implement the methods described herein, and data 154. Any suitable operating system 150 may be employed. One of the program modules 152 may comprise a set of instructions stored on one or more computer- or processor-readable media and executable by one or more processors to implement the methods to generate image data using the machine-readable symbol reader 100 and/or decode the image data. The data 154 may include one or more configuration settings or parameters, or may include image data from the sensor array 110 and decoded machine-readable symbol data.

The machine-readable symbol reader 100 may include a number of other components that interface with one another via the bus 134, including an input/output (I/O) controller 156 and one or more I/O devices 158, and a network interface 160. For example, the I/O controller 156 may implement a display controller and the I/O devices 158 may include a display device to present data, menus, and prompts, and otherwise communicate with the user via one or more display devices, such as a transmissive or reflective liquid crystal display (LCD) or other suitable display. For example, the I/O controller 156 and I/O device 158 may be operable to display a navigable menu system or graphical user interface (GUI) that allows the user to select the illumination and image capture settings.

The I/O controller 156 may receive user input from one or more input devices, such as a trigger, keyboard, a pointing device, or other wired/wireless input devices, that allow the user to, for example, program the machine-readable symbol reader 100. Other input devices may be included, such as a microphone, touchscreen, touchpad, and trackball. While the input devices may be integrated into the machine-readable symbol reader 100 and coupled to the controller 128 via the I/O controller 156, input devices may also connect via other interfaces, such as a connector that includes one or more data interfaces, bus interfaces, wired or wireless network adapters, or modems for transmitting and receiving data.

Accordingly, the I/O controller 156 may include one or more of hardware, software, and firmware to implement one or more protocols, such as stacked protocols along with corresponding layers. Thus, the I/O connector 156 may function as one or more of a serial port (e.g., RS232), a Universal Serial Bus (USB) port, or an IR interface. The I/O controller 156 may also support various wired, wireless, optical, and other communication standards.

Optional network interface 160 may provide communications with one or more hosts or other devices (e.g., a computer, a point-of-sale terminal, a point-of-sale computer system, or a cash register). For example, data gathered by or decoded by the machine-readable symbol reader 100 may be passed along to a host computer. According to one implementation, the network interface 160 comprises a universal interface driver application-specific integrated circuit (UIDA).

The network interface 160 may facilitate wired or wireless communication with other devices over a short distance (e.g., Bluetooth™) or nearly unlimited distances (e.g., the Internet). In the case of a wired connection, a data bus may be provided using any protocol, such as IEEE 802.3 (Ethernet), advanced technology attachment (ATA), personal computer memory card international association (PCMCIA), or USB. A wireless connection may use low- or high-powered electromagnetic waves to transmit data using any wireless protocol, such as Bluetooth™, IEEE 802.11b (or other Wi-Fi standards), infrared data association (IrDA), and radiofrequency identification (RFID).

The machine-readable symbol reader 100 may also include one or more power supplies 162, which provide electrical power to the various components of the machine-readable symbol reader 100 via power connections.

Machine-readable symbol readers according to other implementations may have less than all of these components, may contain other components, or both. In addition, the machine-readable symbol reader 100 may include a radiofrequency identification (RFID) reader or interrogator and/or or a magnetic stripe reader. Such may be particularly useful when employed as a point-of-sale (POS) terminal.

Referring to FIGS. 1 to 10, the machine-readable symbol readers described herein can include any combination of the structures of the machine-readable symbol readers 20 and 100 described above. The machine-readable symbol readers 20, 100 can, for example, include a scan engine which include a sensor array such as sensor array 110, a focus element such as focal element 130, a lens system such as lens system 126, and optionally one or more illumination sources, such as active illumination source 120. Thus, the machine-readable symbol reader 20 can perform in the manner described above for machine-readable symbol reader 100, and can be operated to illuminate and read machine readable symbols within a scan aperture or field of view 112 (referring herein to a region that can be illuminated and/or scanned by a scan engine) that projects forward out of the front of the machine-readable symbol reader 20.

An operator can hold the machine-readable symbol reader 20, 100, in a hand with an outstretched arm, so that the field of view projects outwardly from the front of the machine-readable symbol reader 20, 100 along an axis coincident with, parallel to, or substantially coincident with or parallel to a central longitudinal axis of the operator's forearm. As used herein, the axis along which a field of view projects is the center-most axis of the field of view. Thus, the machine-readable symbol reader can be used by the operator in a standard point-and-shoot manner such that these axes and planes are also coincident with, parallel to, or substantially coincident with or parallel to the operator's line of sight, in some cases perpendicular or substantially perpendicular to gravity.

The following list includes examples of aspects of the disclosure.

Example 1—The machine-readable symbol reader 20, 100, including: the hyperspectral sensor 34 configured to capture image data for the object 10 within the field of view 28 of the hyperspectral image sensor 24, the captured image data including a 3D cubic data set. The machine-readable symbol reader 20, 100 further including the image processor 32 communicatively coupled to the hyperspectral sensor 24 such that a first subset of the captured image data is received by the image processor 32. The first subset of the captured image data is a 2D planar data set that includes a machine-readable symbol carried by the object. The machine-readable symbol reader 20, 100 further including the hyperspectral processor 34 communicatively coupled to the hyperspectral sensor 24 such that a second subset of the captured image data is received by the hyperspectral processor 34, the second subset of the captured image data including a plurality of linear data sets. The hyperspectral processor 34: identifies locations within the captured image data in which the object is present, and communicates the identified locations to the image processor 32. The image processor 32 identifies a region of interest within the first subset of the captured image data, and the region of interest includes a perimeter formed by the identified locations.

Example 2—The machine-readable symbol reader of Example 1, further including a nontransitory storage medium that stores a decoding library. The nontransitory storage medium is communicatively coupled to the image processor 32, and the decoding library contains a database of information about machine-readable symbols.

Example 3—A method of decoding a machine-readable symbol comprising: capturing image data of an object 10 and the machine-readable symbol 12 carried by the object 10 with the hyperspectral sensor 24 of the machine-readable symbol reader 20, 100 when the object 10 and the machine-readable symbol 12 are positioned within the field of view 28 of the hyperspectral sensor 24, the object 10 including a first material. The method further including sending a first subset of the captured image data to the image processor 32 communicatively coupled to the hyperspectral sensor 24. The portion of the captured image data includes at least one 2D planar data set. The method further including sending a second subset of the captured image data to the hyperspectral processor 34 communicatively coupled to the hyperspectral sensor 34; analyzing the second subset of the captured image data to identify locations within the captured image data in which the first material is absent; communicating the identified locations to the image processor 32; identifying a region of interest within the first subset of the captured image data, wherein the region of interest is reduced in size compared to the first subset of the captured image data, and the region of interest excludes the identified locations; and analyzing the region of interest to decode the machine-readable symbol 12.

Example 4—The method of Example 3 wherein analyzing the second subset of the captured image data includes analyzing a range of wavelengths of the electromagnetic spectrum in which the first material is present within the captured image data.

Example 5—The method of Example 4, further including: moving the object 10 relative to the machine-readable symbol reader 20, 100 via a conveyor 62, wherein the conveyor 62 includes a second material, and the analyzed range of wavelengths is one in which the second material is absent from the captured data set.

Example 6—The method of Example 4, further including: moving the object 10 relative to the machine-readable symbol reader 20, 100 via a conveyor 62, wherein the excluded identified locations include captured image data of the conveyor 62.

Example 7—A method of reducing a captured image data set including: capturing a 3D cubic data set of image data of the object 10 with the hyperspectral sensor 24 when the object 10 is positioned within the field of view 28 of the hyperspectral sensor 24, wherein the 3D cubic data set includes a plurality of 2D planar data sets each captured within respective discrete ranges of wavelengths of the electromagnetic spectrum; identifying a subset of the 3D cubic data set that includes all of the plurality of 2D planar data sets captured within discrete range of wavelengths of the electromagnetic spectrum that are between a minimum wavelength and a maximum wavelength; determining a signal intensity for each pixel of the 2D planar data set within each of the discrete range of wavelengths of the electromagnetic spectrum that are between the minimum wavelength and the maximum wavelength; calculating a cumulative signal intensity for each pixel of the 2D planar data set by summing the signal intensity of each pixel across each of the discrete range of wavelengths of the electromagnetic spectrum that are between the minimum wavelength and the maximum wavelength; comparing the cumulative signal intensity for each pixel of the 2D planar data set to a threshold value; and identifying a region of interest within the 2D planar data set that includes only those pixels in which the cumulative signal intensity is greater than or equal to the threshold value.

Example 8—The method of Example 7, further including: excluding from the region of interest those pixels within the 2D planar data set in which the cumulative signal intensity is less than the threshold value.

Example 9—The method of Example 7 wherein the region of interest is a continuous area within the 2D planar data.

Example 10—The method of Example 9 wherein the region of interest is a square or rectangular shape within the 2D planar data.

Example 11—The method of Example 7, further including: capturing image data of the machine-readable symbol 12 carried by the object 10, wherein the machine-readable symbol 12 is positioned within the region of interest.

Example 12—The method of Example 9 wherein at least one of the minimum wavelength and the maximum wavelength is outside the visible spectrum of the electromagnetic spectrum.

Example 13—A method of reducing a captured image data set including: capturing a 3D cubic data set of image data of the object 10 with the hyperspectral sensor 24 when the object 10 is positioned within the field of view 28 of the hyperspectral sensor 24, wherein the 3D cubic data set includes a plurality of 2D planar data sets each captured within respective discrete ranges of wavelengths of the electromagnetic spectrum; identifying a subset of the 3D cubic data set that includes one of the 2D planar data sets captured within a discrete range of wavelengths of the electromagnetic spectrum; determining a signal intensity for each pixel of the 2D planar data set of the subset; comparing the signal intensity for each pixel of the 2D planar data set of the subset to a threshold value; and identifying a region of interest within the 2D planar data set of the subset that includes only those pixels in which the signal intensity is greater than or equal to the threshold value.

Example 14—The method of Example 13, further including: excluding from the region of interest those pixels within the 2D planar data set of the subset in which the signal intensity is less than the threshold value.

Example 15—The method of Example 13 wherein the region of interest is a discontinuous area within the 2D planar data set of the subset.

Example 16—The method of Example 13 wherein the region of interest is the machine-readable symbol 12.

Example 17—The method of Example 16, further including: decoding the machine-readable symbol 12 to identify the object 10.

Example 18—The method of any one of Example 13 to 17, further including: printing the machine-readable symbol 12 with a hyperspectral ink, the hyperspectral ink having a signal intensity above the threshold value within the discrete range of wavelengths of the electromagnetic spectrum.

Example 19. The method of Example 18, further including: securing the machine-readable symbol 12 to the object 10.

Various embodiments of the apparatus, devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof.

In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer-readable medium for use by or in connection with any computer and/or processor related system or method. In the context of this document, a memory is a computer-readable medium that is an electronic, magnetic, optical, or other another physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any means that can store, communicate, propagate, or transport the program associated with logic and/or information for use by or in connection with the instruction execution system, apparatus, and/or device. The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of non-transitory signal bearing media include, but are not limited to, the following: recordable type media such as floppy disks, hard disk drives, CD ROMs, digital tape, and computer memory; and transitory or transmission type media such as digital and analog communication links using TDM or IP based communication links (e.g., packet links).

Those of skill in the art will recognize that many of the methods or algorithms set out herein may employ additional acts, may omit some acts, and/or may execute acts in a different order than specified. The various embodiments described above can be combined to provide further embodiments. Aspects of the embodiments can be modified, if necessary, to employ additional systems, circuits and concepts to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A machine-readable symbol reader, comprising:
a hyperspectral sensor configured to capture image data of an object within a field of view of the hyperspectral sensor, the captured image data including a 3D cubic data set, wherein the 3D cubic data set includes a plurality of 2D planar data sets, each of the plurality of 2D planar data sets captured within a discrete range of wavelengths of the electromagnetic spectrum; and
an image processor communicatively coupled to the hyperspectral sensor such that a first subset of the captured image data is received by the image processor and a second subset of the captured image data is excluded from the image processor, wherein the first subset of the captured image data includes at least one of the plurality of the 2D planar data sets captured at a selected one of the discrete ranges of wavelengths of the electromagnetic spectrum, wherein each of the selected ones of the discrete range of wavelengths is a range of wavelengths in which at least a portion of a machine-readable symbol carried by the object is present and a background of the object is absent.

2. The machine-readable symbol reader of claim 1, further comprising:
a nontransitory storage medium that stores a decoding library, the nontransitory storage medium communicatively coupled to the image processor, the decoding library containing a database of information about machine-readable symbols.

3. The machine-readable symbol reader of claim 1 wherein the second subset of captured image data includes at least one of the plurality of the 2D planar data sets captured at a non-selected one of the discrete range of wavelengths of the electromagnetic spectrum, wherein each of the non-selected ones of the discrete range of wavelengths is a range of wavelengths in which the background of the object is present.

4. The machine-readable symbol reader of claim 1 wherein the second subset of captured image data includes at least one of the plurality of the 2D planar data sets captured at a non-selected one of the discrete range of wavelengths of the electromagnetic spectrum, wherein each of the non-selected ones of the discrete range of wavelengths is a range of wavelengths in which both the machine-readable symbol carried by the object and the background are present.

5. The machine-readable symbol reader of claim 1 wherein at least one of the selected ones of the discrete range of wavelengths is outside of the visible spectrum of the electromagnetic spectrum.

6. The machine-readable symbol reader of claim 1 wherein each of the selected ones of the discrete range of wavelengths is outside of the visible spectrum of the electromagnetic spectrum.

7. The machine-readable symbol reader of claim 1 wherein the background is a surface of the object.

8. The machine-readable symbol reader of claim 1 wherein the background is a label upon which the machine-readable symbol is printed, and the label is secured to the object.

9. A method of decoding a machine-readable symbol, the method comprising:
capturing image data of an object and a machine-readable symbol carried by the object with a hyperspectral sensor of a machine-readable symbol reader when the object and the machine-readable symbol are positioned within a field of view of the hyperspectral sensor, wherein the machine-readable symbol is formed by a first material and the object includes a second material that forms no part of the machine-readable symbol;
identifying at least one range of wavelengths of the electromagnetic spectrum in which the first material is present within the captured image data and the second material is absent from the captured image data;
sending a portion of the captured image data to an image processor communicatively coupled to the hyperspectral sensor, wherein the portion of the captured image data includes at least one 2D planar data set captured at the identified at least one range of wavelengths; and
decoding the machine-readable symbol.

10. The method of claim 9 wherein the first material is an ink.

11. The method of claim 10 wherein the second material forms a label upon which the ink is printed to form the machine-readable symbol.

12. The method of claim 11 wherein the label includes written indicia that form no part of the machine-readable symbol.

13. The method of claim 9 wherein:
identifying the at least one wavelength includes identifying a plurality of ranges of wavelengths of the electromagnetic spectrum;
sending a portion of the captured image data to the image processor includes sending a plurality of 2D planar data sets; and
each of the plurality of 2D planar data sets is captured at respective ones of the identified plurality of ranges of wavelengths.

14. The method of claim 9 wherein decoding the machine-readable symbol includes accessing a decoding library that contains a database of information about machine-readable symbols, the decoding library being communicatively coupled to the image processor.

15. The method of claim 14 wherein accessing the decoding library includes inputting only the portion of the captured image data to the decoding library, the portion of the captured image data including only 2D planar data sets captured at the identified at least one range of wavelengths in which the first material is present within the captured data set and the second material is absent from the captured data set.

16. The method of claim 9 wherein decoding the machine-readable symbol includes identifying the object based on the decoded machine-readable symbol.

17. The machine-readable symbol reader of claim 9 wherein at least one of the identified at least one range of wavelengths is outside of the visible spectrum of the electromagnetic spectrum.

18. The machine-readable symbol reader of claim 9 wherein each of the selected ones of the identified at least one range of wavelengths is outside of the visible spectrum of the electromagnetic spectrum.

19. A machine-readable symbol reader, comprising:
a hyperspectral sensor configured to capture image data for an object within a field of view of the hyperspectral image sensor, the captured image data including a 3D cubic data set;
an image processor communicatively coupled to the hyperspectral sensor such that a first subset of the captured image data is received by the image processor, wherein the first subset of the captured image data is a 2D planar data set that includes a machine-readable symbol carried by the object;
a hyperspectral processor communicatively coupled to the hyperspectral sensor such that a second subset of the captured image data is received by the hyperspectral processor, wherein the second subset of the captured image data includes a plurality of linear data sets,
wherein the hyperspectral processor:
identifies locations within the captured image data in which the object is absent, and
communicates the identified locations to the image processor,
wherein the image processor identifies a region of interest within the first subset of the captured image data, the region of interest excluding the identified locations.

20. The machine-readable symbol reader of claim 19, further comprising:
a nontransitory storage medium that stores a decoding library, the nontransitory storage medium communicatively coupled to the image processor, the decoding library containing a database of information about machine-readable symbols.
